(19) United States
(12) Patent Application Publication
(10) Pub. No.: US 2023/0332389 A1
(43) Pub. Date: Oct. 19, 2023

(54) ADJUSTABLE SURROUND FOR A SINK

(71) Applicant: BUSINESS 2U LTD, Glasgow Central Scotland (GB)

(72) Inventor: Richard Neilson, Glasgow Central Scotland (GB)

(73) Assignee: BUSINESS 2U LTD, Glasgow Central Scotland (GB)

(21) Appl. No.: 16/620,574

(22) PCT Filed: May 14, 2018
(86) PCT No.: PCT/GB2018/051292

§ 371 Date: Dec. 9, 2019

(30) Foreign Application Priority Data
Jun. 9, 2017 (GB) 1709251.1

(51) Int. Cl. E03C 1/181

(52) U.S. Cl. CPC E03C 1/181

(57) ABSTRACT

The invention relates to a detachable adjustable surround for shielding a surface around a sink. The surround comprises a pair of shield portions, an attachment member on each shield portion for detachably securing the surround to a periphery of the sink, and an adjustment portion. The adjustment portion includes first and second couplings which are attached to the shield portions. The couplings are arranged in order to retain an adjustment member, and the adjustment member is movable with respect to at least one of the couplings to adjust the distance between the shield portions.

The present invention relates to an adjustable detachable surround and splash guard, particularly, but not exclusively, a surround and splash guard to act as a shield to restrict liquids damaging worktops and surfaces around sink units and the like.

Water is often splashed in and around the area of a sink during normal use. Sinks often have a self-draining area designed to receive water. However, adjacent worktops, surfaces and walls in the region of the sink may not be waterproof and/or may contain joins, gaps, and cracks that allow water ingress. The water and liquids splashed onto these areas can have negative consequences. Resultant staining and water damage can occur on these surfaces, which negatively affect the aesthetic appearance. In addition, water seeping through joins, and cracks can soak into relatively absorbent materials such as chipboard and untreated wood. This can result in unsanitary conditions due to proliferation of bacteria, whose growth is stimulated by a damp environment. Even where sealant is used to join the self-draining part of sinks and worktops, the functional life of sealant is typically less than that of the sink, with the result that most sink areas will be vulnerable to the damaging effects of splashed liquids.

According to a first aspect of the present invention there is provided a detachable adjustable surround for shielding at least a portion of a surface around a sink, the surround comprising:
at least two upright shield portions which project above the level of the sink and which allow fluid which has been shielded from contact with the surface around the sink to run down toward the sink under the action of gravity;
at least one attachment member provided on each upright shield portion for detachably securing the surround to a periphery of the sink; and
an adjustment portion including first and second couplings attached to the at least two upright shield portions respectively, wherein the couplings are arranged to retain an adjustment member, and wherein the adjustment member is movable with respect to at least one of the couplings to adjust the distance between the upright shield portions.

Thus, the invention provides a surround to shield adjacent worktops by retaining water within a self-draining sink area and restricting egress of liquids to external surfaces that may not be specially constructed to receive water. Use of the surround in the sink area protects work surfaces around the sink and shields them from water damage, stains, and bacteria.

Preferably, in use, the surround may shield at least a portion of the surfaces around a water source, such as taps or a fountain. The adjustment member may be located in the region of the water source in use. Therefore, the surround can be adjusted to modify the distance between the shield portions to allow the surround to fit around different styles and sizes of taps. The surround does not impede normal operation of the taps, since the adjustment member spaces the shield portions from the taps.

Each shield portion may have an elongate body to provide at least one substantially planar face to act as a protective barrier to splashes. The elongate body also has relatively narrow edges bordering the planar face. Thus, the shield portions provide planar surfaces that can extend upwardly from the sink to form a physical barrier around the sink and protect adjacent work surfaces from undesirable splashing that might otherwise cause damage, staining and bacterial growth.

Preferably, the at least one attachment member detachably secures the lower edge of each shield portion on a surface at the periphery of the sink in use, such that the planar faces extend substantially perpendicular relative to surfaces around the sink.

The at least one attachment member provided on each shield portion may be arranged to detachably secure the surround in use on at least two sides of a water source, such as taps or a fountain.

The adjustment member may comprise a connector that is located within the couplings and connects the shield portions. The connector may be slidably located within at least one of the couplings. The adjustment member may comprise a strip of material. The adjustment member may be made from rubber.

The adjustment portion provides a connection between the shield portions. The fact that the adjustment member is movable within at least one of the couplings enables relative movement of the shield portions to adjust the distance therebetween. Thus, the length of the surround can be adjusted according to the length of the periphery of the sink and the desired level of protection of adjacent surfaces. A rubber adjustment member also enables the detachable surround to be fitted around taps, since it may elastically deform to allow placement around sink furniture which would otherwise inhibit placement of a protective shield around the sink.

At least one of the first and second couplings may comprise a slot, wherein the adjustment member is slidable within the slot to adjust the distance between the shield portions.

The first and second couplings may be fixed to each shield portion by fixings. The couplings may be fixed to each shield portion on a planar face. The coupling may be fixed to the rear planar face of each shield portion opposing the sink area in use.

The adjustment member may be slideable within both couplings. Both the first and second couplings may comprise slots, such that the adjustment member is movable within each slot.

The adjustment portion may include a retainer to retain the adjustment member within the couplings. The adjustment member may include a retainer to retain the adjustment member within the couplings. The adjustment member may comprise end stops to retain the adjustment member within the couplings.

The adjustment portion is advantageous since it allows the surround to be fitted and positioned around most sink configurations and sizes in use.

Preferably, the shield portions extend around at least part of two sides of a sink in use. The shield portions may extend around at least part of three sides of a sink in use.

At least one of the shield portions may include a right angle such that the shield portion presents two perpendicular substantially planar faces to shield at least a portion of surfaces around two sides of a sink in use.

Preferably, the surround comprises two shield portions each having a right angle and presenting four planar faces to shield surfaces around a sink in use.

Preferably, the surround has an open side to allow access to a front of the sink in use.

The surround may further comprise a redirection means adapted to redirect liquids into a sink in use.

The redirection means may comprise a shaped surface located on at least a portion of one of the shield portions. The redirection means may comprise a shaped surface located on each of the shield portions. The redirection means may comprise a shaped surface located on the planar face of the shield portions. The redirection means may comprise a shaped surface located towards a lower edge of the shield portions.

The redirection means may comprise an angled surface arranged to direct liquids into the sink. The redirection means may comprise an inclined portion located towards a lower edge of the shield portions and inclined relative to the planar faces of the shield portions.

Alternatively, or additionally, the redirection means may comprise a shaped groove located towards a lower edge the shield portions. The redirection means can comprise a continuous shaped groove located on a lower edge of the shield portions wherein the groove is shaped to encourage droplet formation. The groove may be shaped to encourage droplet coalescence.

Preferably, the groove is shaped in section as a right angled triangle and includes a step and an inclined surface. The groove may also include a continuous band fixed alongside an outer edge of the groove. The band may be a strip of silicon.

Alternatively, the groove can be a semi-circular shape in section or a V-shaped notch in section.

The width of the groove may be between 1 mm and 5 mm. The width of the groove may be around 3 mm.

The depth of the groove may be between 1 mm and 5 mm. The depth of the groove may be around 2.5 mm.

Alternatively or additionally, the redirection means comprises shield portions having low roughness to promote droplet rolling along the redirection means in use.. The shield portion having low roughness may also reduce surface tension between the surface and the liquid droplets in use.

The shield portions may be constructed from a material having low surface roughness. The shield portion may be provided with a coating to reduce surface roughness.

The shield portions may be constructed from a plastic material. The shield portions may be a moulded plastic. The shield portions may be extruded plastic. The shield portions may be a coloured plastic.

Preferably, the surround is retrofittable to existing sinks. Preferably, the surround is portable.

Holders, clips and containers may be provided for use in conjunction with the surround. The holder may comprise a lip shaped to cooperate with an upper edge of the shield members of the surround. The holder may comprise a container for receiving items such as cloths, sponges, washing liquids, utensils and the like. The holder may also comprise drain apertures located on a lower surface of the container.

According to a second aspect of the invention, there is provided a splash guard for protecting surfaces around a wet area, the guard comprising at least one shield portion with at least one surface arranged to receive splashes of liquids around the wet area in use and a redirection means for redirecting droplets of liquid into the wet area in use, the redirection means comprising a groove located towards a base of the shield portion.

The groove can be shaped to cause drops of liquid to cohere in use. The groove can be formed on an underside of the shield portion. The groove can be shaped as a right angled triangle in section.

The redirection means may also comprise an angled surface towards a base of the at least one shield portion to redirect droplets of liquid to the wet area in use.

The splash guard of the second aspect of the invention can be used around any wet area to protect against and redirect splashed liquids.

All features, embodiments and uses of the first aspect of the invention are equally applicable to the second aspect of the invention where appropriate and vice versa.

Further features and advantages of the first and second aspects of the present invention will become apparent from the claims and the following description.

Embodiments of the present invention will now be described by way of example only, with reference to the following diagrams, in which:-

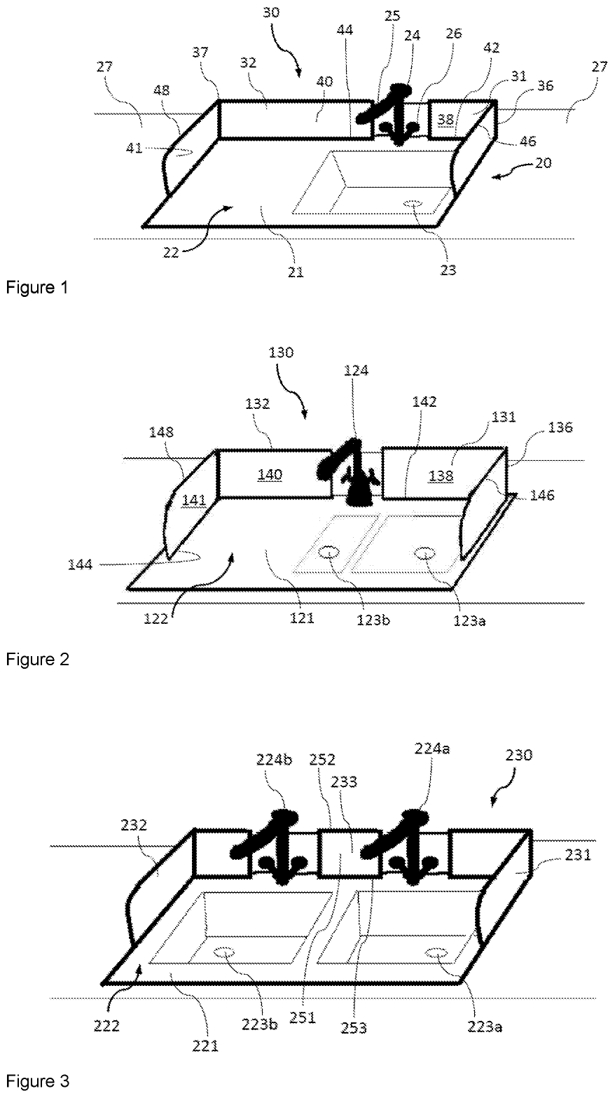

FIG. 1 is a perspective view of a sink area and an adjustable surround according to a first embodiment of the present invention;

FIG. 2 is a perspective view of a sink area and an adjustable surround according to another embodiment of the present invention;

FIG. 3 is a perspective view of a sink area and an adjustable surround according to another embodiment of the present invention;

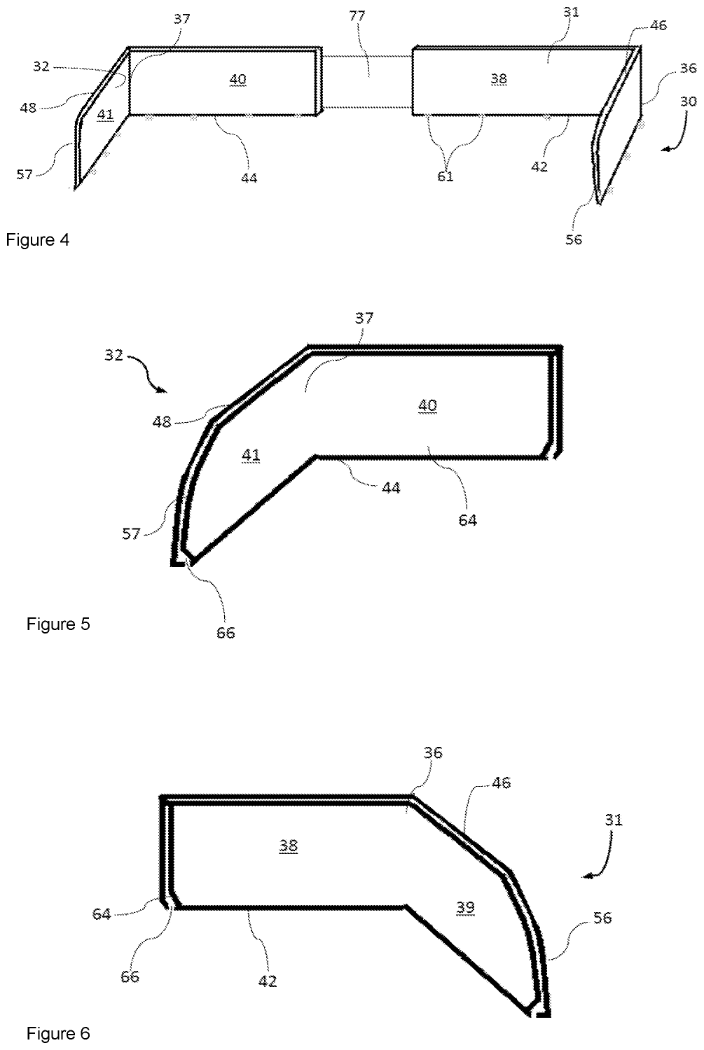

FIG. 4 is a perspective view of the surround of FIG. 1;

FIG. 5 is a perspective view of a shield portion of the adjustable surround of FIG. 1;

FIG. 6 is a perspective view of another shield portion of the adjustable surround of FIG. 1;

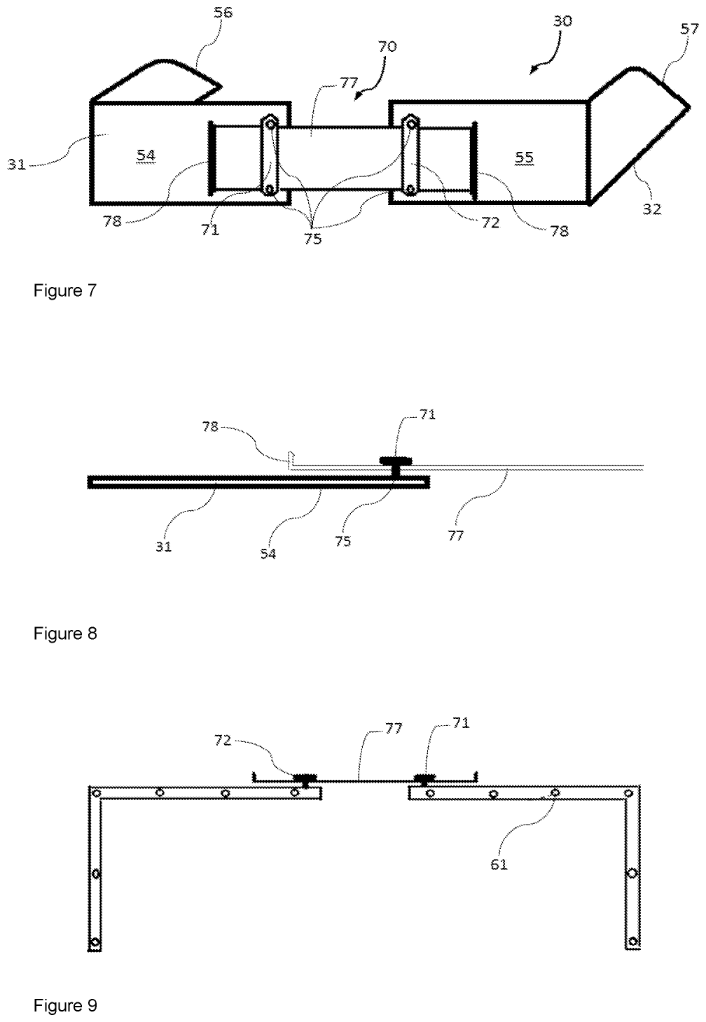

FIG. 7 is a perspective view of an adjustment portion of the adjustable surround of FIG. 1;

FIG. 8 is a top view of part of the adjustable surround of FIG. 1;

FIG. 9 is a bottom view of the adjustable surround of FIG. 1;

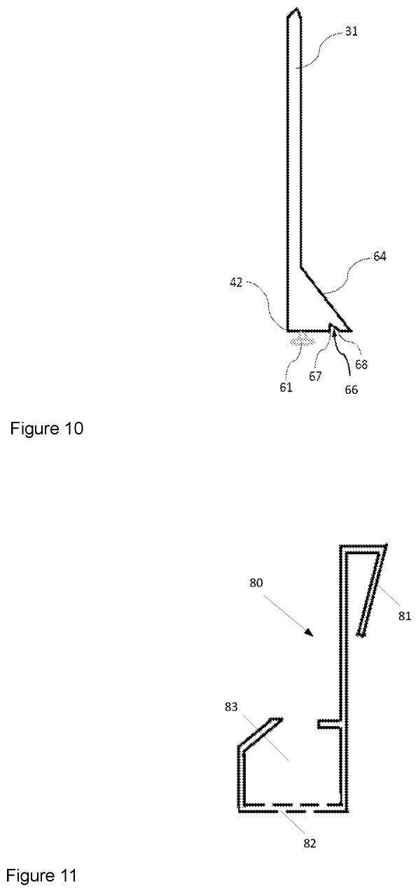

FIG. 10 is a sectional view through the shield portion of the adjustable surround of FIG. 1; and

FIG. 11 is a sectional view through an accessory for the adjustable surround.

An adjustable surround according to a first embodiment of the present invention is shown generally at 30 in FIG. 1. The surround 30 is shown positioned in use around a sink unit 20.

The sink unit 20 has an opening through which a tap 24 protrudes. The tap 24 has a control 26 for controlling the supply of water through a spout 25. The sink unit 20 has a self-drain area 22 and is constructed such that any liquids collecting in the self-drain area 22 are aided by gravity to travel towards a drain 23 located at the lowest point in the sink unit 20. The sink unit 20 is made from a waterproof material 21, for example, ceramic or stainless steel. As a result, water and liquids used in the sink unit 20 do not have an adverse impact on the longevity or aesthetics of the sink unit 20.

The sink unit 20 is mounted into a recessed area in a worktop 27. The worktop 27 extends around the sink unit 20 and is made from a treated wood. Prolonged exposure of the worktop 27 to water or liquids will cause degradation of the materials and lead to damage of the worktop 27 over time. The join between the sink area 20 and the worktop 27 is sealed with a sealant that has a limited lifetime.

The surround 30 according to the invention prevents water damage of the worktop 27 by acting as a splashguard to shield the worktop 27 and join by reducing harmful exposure to water and liquids and by redirecting liquids into the self-draining area 22 of the sink unit 20.

The surround 30 in FIG. 1 is shown retrofitted around the sink unit 20 and tap 24. The surround 30 is shown in more detail in an unmounted configuration in FIG. 4.

The surround 30 comprises two shield portions 31, 32 in the form of extruded plastic elongate members. Each shield portion 31, 32 is bent to form a 90° angle 36, 37 such that two perpendicular faces 38, 39, 40, 41 are formed as shown in FIGS. 5 and 6. These faces 38, 39, 40, 41 present a large barrier surface facing the sink area 20 to act as a splash guard. The shield portions 31, 32 are made from a coloured plastic having low surface roughness to enhance aesthetic appeal and encourage run-off.

The shield portions 31, 32 have a lower edge 42, 44 to which attachment members in the form of a plurality of equispaced suction cups 60 are fixed. The suction cups 60 are shown in more detail in FIGS. 9 and 10 and are small in size so that they fit on the periphery of most sink units. The suction cups 60 are easy to use and allow the surround 30 to be temporarily secured and retrofitted around the sink unit 20. The suctions cups 60 are advantageous since they allow the surround 30 to be fitted alongside the sink unit 20 without the need for specialist tooling or adhesive. The ability to easily detach the suction cups 60 means that each surround 30 is removable and portable for use on other sink units.

Each shield portion 31, 32 has a redirection means shown in section in FIG. 10. The redirection means includes an angled surface 64 located towards the lower edge 42, 44 of each planar face 38, 39, 40, 41. The surface 64 is angled relative to the planar faces 38, 39, 40, 41. The angled surface 64 directs droplets of liquid towards the self-draining area 22 of the sink unit 20 in use. The redirection means also includes a groove 66 extending continuously along the lower edge 42, 44 of each shield portion 31, 32. The groove 66 is a right-angled triangle in section and has an inclined part 68 leading to a step 67. The depth of the step 67 is 2.5 mm and the width of the groove 66 is 3 mm. The size and shape of the groove 66 has been empirically determined to enhance droplet coalescence and therefore encourage droplet runoff from the shield portions 31, 32. Locating the groove 66 on the underside of the lower edge 42, 44 of the shield portions 31, 32 enhances the component of gravitational force acting on the droplets of liquid caught in the groove 66. This aids the objective of the invention since liquids are redirected to the self-draining area 22 of the sink unit 20, which is specifically designed to withstand exposure to liquids.

The shield portions 31, 32 are spaced and aligned at a first end, and joined by an adjustment portion 70. The adjustment portion 70 is fixed to a rear planar surface 54, 55 (opposing the planar surface 38, 40 facing the sink unit 20 in use) of each shield portion 31, 32 respectively. The adjustment portion 70 includes two slots 71, 72 that are fixed towards their upper and lower ends to the rear planar faces 54, 55 by fixings 75. The slots 71, 72 slidably receive an adjustment member in the form of a rubber band 77. The rubber band 77 comprises a strip of rubber having end stops 78 at each end to retain the band 77 within the slots 71, 72. Sliding the band 77 within the slots 71, 72 allows the distance between the first ends of the shield portions 31, 32 to be adjusted. This allows placement of the surround 30 around different sizes and configurations of sink unit to account for and allow taps 24 to be used without impediment. The adjustment means 70 allow the surround 30 to be positioned either on the rim of the sink unit 20 or on the surrounding worktop 27 with the angled surface 64 of the redirection means protruding over the self-draining area 22 of the sink unit 20. Adjusting the band 77 within the slots 71, 72 also enables the overall length of the surround 30 to be varied to fit alongside different sizes of sink unit 20. The band 77 is made of rubber to allow some deformation where the surround 30 is required to fit around sink furniture.

The distal ends 56, 57 of the shield portions 31, 32 are shaped in a gradual curve to improve aesthetics of the surround 30 and remove any potentially harmful sharp edges.

Prior to use, the surround 30 is retrofitted around the back and sides of the sink unit 20. The adjustment means 70 is suitably adjusted by slidably moving the band 77 within the slots 71, 72 to ensure the gap between the first ends of the shield portions 31, 32 enables optimum placement around the taps 24 and adjusts the overall length of the surround 30 to fit along the rear of the sink unit 20. The surround 30 is then pressed into the desired position such that the suction cups 60 engage with the periphery of the sink unit 20 to attach the surround 30 in the position in which it will be used. The lightweight surround combined with the lack of forces applied mean that the surround 30 is stable once attached. In this position the surround 30 is open at the front of the sink unit 20 to allow free access for a user to complete tasks in the self-draining 22 area.

During use of the sink unit 20 with the surround 30 installed, splashed water and liquids land on the planar faces 38, 39, 40, 41 of the shield portions 31, 32 at the back and sides of the sink. The surround 30 therefore prevents these splashes from landing on joins between the sink unit 20 and the worktop 27 as well as on the worktop 27 itself. This protects the worktop 27 and joins from water damage, staining and harmful bacteria growth. In addition, the surround 30 has the additional benefit that water and liquids are redirected towards the self-draining area 22 of the sink unit 20. The angled surface 64 directs the flow of water inwardly towards the self-draining area 22. Any droplets wicking underneath the edges 42, 44 of the shield portions 31, 32 due to surface tension effects, reach the triangular groove 66. The groove 66 arrests further movement of droplets and causes them to cohere. Once the droplets reach a critical mass, gravitational forces exceed surface tension between the droplet and the shield portion 31, 32, and the droplet falls into the self-draining area 22 of the sink unit 20.

Thus the retrofit surround 30 of the first embodiment of the invention prevents water and liquids from splashing around the worktop 27 in the area of the sink unit 20 and further redirects liquids into the self-draining area 22 of the sink unit 20.

Clip on accessories, such as sponge, cloth and/or cleaning fluid holders may also be provided that clip onto the upper edge 46, 48 of the elongate members 31, 31. One embodiment of a holder 80 is shown in FIG. 11. The moulded plastic holder 80 has a lip 81 that rests in use over the upper edge 46, 48 of the shield portion 31, 32. The holder 80 has a container 83 for holding various sink accessories, such as cloths, sponges, spoons and the like. The base of the container 83 has drain holes 82 to allow liquids to enter to self-draining area 22 of the sink unit 20. These clips and/or holders 80 add value and functionality.

The redirection means may further include manufacturing the shield portions 31, 32 from an appropriate material having low surface roughness to minimise surface tension effects between the drops of liquid on the surface of the shield portions 31, 32. Alternatively, the shield portions 31, 32 may be coated or sprayed with a non-stick coating to encourage liquids to runoff into the self-draining area 22 of the sink unit 20.

According to alternative embodiments, different grooves can be formed in the lower edge of the shield portions 31, 32. A groove in the form of a semi-circular notch in section can be located along the lower edge 42, 44 of the shield portions 31, 32. Alternatively, an equilateral triangular notch in section can by formed along the lower edge 42, 44. According to yet another embodiment a thin silicone band can be fixed along the stepped 67 edge of the groove 66 to encourage droplet detachment.

The surround 30 can be manufactured in a range of colours and textures to enhance aesthetic appeal.

The exact shape and size of the shield portions 31, 32 including the relative dimensions, lengths and areas of the planar surfaces 38, 39, 40, 41 can be altered and determined according to the application and particular sink unit 20 and tap 24 configuration.

With reference to FIGS. 2 and 3, two further embodiments of the present invention will now be described. In order to minimise repetition, similar features of the apparatus described subsequently are numbered with a common two-digit reference numeral and are differentiated by a third digit placed before the two common digits. Such features are structured similarly, operate similarly, and/or have similar functions.

FIG. 2 shows a further embodiment of the invention with a surround 130 having altered dimensions to fit a different sink unit 120 configuration, with a centrally located tap 124. Reference numerals for all similar features are preceded with a ‘1’ before the two common digits. The surround 130 functions in the same manner as described above with the planar faces 138, 140, 141 acting as a splash guard to protect the surrounding worktop 127 and redirection means for redirecting droplets into the self-draining area 122 of the sink unit 120.

FIG. 3 shows a surround 230 according to another embodiment of the invention. The surround 230 is designed to fit around a sink unit 220 having two taps 224a, 224b, such as those commonly found in commercial premises. The surround 230 includes an additional central shield portion 233 in the form of an elongate member. The shield portion 233 is located between the shield portions 231, 232 that protect part of the rear and sides of the sink unit 220. A rear face 252 of the central shield portion 233 has slots fixed thereto to enable coupling of the central shield portion 233 via the rubber band as previously described. The central shield portion 233 has a planar face 251 to form a splash guard towards the base of which the angled surface acts as a redirection means. A lower edge 253 is provided with the groove 66 previously described with reference to the first embodiment of the invention.

FIG. 10 shows an embodiment according to a second aspect of the invention. The shield portion 31 acts as a splash guard to restrict splashes of liquid and redirection means are provided in the form of the angled surface 64 and the groove 66. Such a shield portion 31 and redirection means can be used around any wet area to protect surfaces from unwanted splashes and redirect water into the wet area in use.

All features, aspects and uses of the first embodiment are equally applicable to the subsequent embodiments of the invention where appropriate and vice versa.

Although particular embodiments of the invention have been disclosed herein in detail, this is by way of example and for the purposes of illustration only. The aforementioned embodiments are not intended to be limiting with respect to the scope of the statements of invention and/or appended claims.

“Sink” in the context of the described invention and claims can be taken to mean any area including a water source, such as taps, fountains and the like, and a region arranged to receive, contain and/or collect water. The area may also include any drain, sump or overflow. “Sink” should therefore be considered to include any area that performs a similar function including areas known as or referred to as ‘basin’, ‘trough’, ‘fawcett’ ‘bath’ and the like. The surround described can be used and installed in any commercial premises including but not limited to kitchens, factories, cafes, and the like, domestic locations, such as bathrooms, utility rooms, kitchens, wet rooms, and the like, educational establishments, such as laboratories, classrooms, kitchens and the like, or temporary settings, such as shelters, cabins, portable toilets, caravans, and the like.

“Adjustable” in the context of the present invention is intended to include the option of extending, retracting and maintaining the length of the surround.

It is contemplated by the inventors that various substitutions, alterations, and modifications may be made to the invention without departing from the spirit and scope of the invention as defined by the statements of invention and/or appended claims. For example: -

Alternative couplings may be used to secure the adjustment member in position.

Although the embodiment described refers to a rectangular shaped sink and sink area, due to the flexible and resilient nature of the surround 30 components (which may comprise a resilient silicone or similar material) the invention may equally be applied around any shape of sink including e.g. a round or oval shaped sink.

1. A detachable adjustable surround for shielding at least a portion of a surface around a sink, the surround comprising:
at least two upright shield portions which project above the level of the sink and which allow fluid which has been shielded from contact with the surface around the sink to run down toward the sink under the action of gravity;
at least one attachment member provided on each upright shield portion for detachably securing the surround to a periphery of the sink; and
an adjustment portion including first and second couplings attached to the at least two upright shield portions respectively, wherein the couplings are arranged to retain an adjustment member, and wherein the adjustment member is movable with respect to at least one of the couplings to adjust the distance between the upright shield portions.

2. The surround according to claim 1, wherein each shield portion has an elongate body to provide at least one planar face to act as a protective barrier, and relatively narrow edges bordering the planar face, and wherein the at least one attachment member detachably secures the lower edge of each shield portion to a surface at the periphery of the sink in use, such that the planar faces extend substantially perpendicular relative to surfaces around the sink.

3. The surround according to claim 1, wherein the adjustment member comprises a connector that connects the shield portions, wherein the connector is a strip of rubber that is slidable within at least one of the couplings.

4. The surround according to claim 1, wherein each coupling comprises a slot fixed to each shield portion and wherein the adjustment member is slidable within the slots to adjust the distance between the shield portions, and wherein the adjustment portion further includes a retainer to retain the adjustment member within the couplings.

5. The surround according to claim 1, wherein at least one of the shield portions includes a right angle such that the shield portion presents two perpendicular substantially planar faces to shield at least a portion of surfaces around two sides of a sink in use.

6. The surround according to claim 1, wherein the surround comprises two shield portions each having a right angle and presenting four planar faces to shield surfaces around at least part of three sides of a sink in use.

7. The surround according to claim 1, wherein the surround has an open side to allow access to a front of the sink in use.

8. The surround according to claim 1, further comprising a redirection component arranged to redirect liquids into the sink in use.

9. The surround according to claim 8, wherein the redirection component comprises an inclined portion located towards a lower edge of the shield portions, wherein the inclined portion is inclined relative to a planar face of the shield portions.

10. The surround according to claim 8, wherein the redirection component comprises a continuous shaped groove located on a lower edge of the shield portions wherein the groove is shaped to encourage droplet formation or droplet coalescence.

11. The surround according to claim 10, wherein the groove is triangular in section and includes a step and an inclined surface.

12. The surround according to claim 8, wherein the redirection component comprises a surface of the shield portion having low surface roughness to promote droplet rolling along the redirection component in use.

13. A splash guard for protecting surfaces around a wet area, the splash guard comprising at least one shield portion with at least one surface arranged to receive splashes of liquids around the wet area in use and a redirection component for redirecting droplets of liquid into the wet area in use, the redirection component comprising a groove located towards a base of the shield portion.

14. The splash guard according to claim 13, wherein the groove is formed on an underside of the shield portion and shaped to cause drops of liquid to cohere within the groove in use.

15. The splash guard according to claim 13, wherein the groove is triangular in section and comprises an inclined portion and a step.

16. The splash guard according to claim 13, wherein the redirection component comprises an angled surface towards a base of the at least one shield portion to redirect droplets of liquid to the wet area in use.

17. A non-transitory computer-readable medium, the non-transitory computer-readable medium having computer-executable instructions adapted to cause a 3D printer to print a detachable adjustable surround for shielding at least a portion of a surface around a sink, the surround comprising:
at least two upright shield portions which project above the level of the sink and which allow fluid which has been shielded from contact with the surface around the sink to run down toward the sink under the action of gravity;
at least one attachment member provided on each upright shield portion for detachably securing the surround to a periphery of the sink; and
an adjustment portion including first and second couplings attached to the at least two upright shield portions respectively, wherein the couplings are arranged to retain an adjustment member, and wherein the adjustment member is movable with respect to at least one of the couplings to adjust the distance between the upright shield portions.

18. (canceled)
